(19) United States
(12) Patent Application Publication
(10) Pub. No.: US 2020/0041819 A1
(43) Pub. Date: Feb. 6, 2020

(54) System and method for attaching accessories to eyewear

(71) Applicant: Hannah Lynn Widmer, Minneapolis, MN (US)

(72) Inventor: Hannah Lynn Widmer, Minneapolis, MN (US)

(21) Appl. No.: 16/261,202

(22) Filed: Jan. 29, 2019

Related U.S. Application Data
(60) Provisional application No. 62/713,306, filed on Aug. 1, 2018.

(51) Int. Cl. G02C 11/02; A44C 15/00

(52) U.S. Cl. CPC G02C 11/02; A45D 8/36; A44C 15/005; A44C 15/003

(57) ABSTRACT

A system and method for attaching one or more accessories to an eyewear frame for user wearing. A first tubular sleeve comprising a first end, a second end, and a length extending there between is configured to slidably secure to an arm portion of an eyewear frame such that the length covers a portion of the eyewear frame and at least a portion of an external surface of the length comprises an attachment surface for securely coupling to a secondary attachment surface where the secondary attachment surface is secured to at least one accessory. The accessory may be a necklace, dangling adornment, fabric drape, headband or a combination thereof.

### CROSS-REFERENCE TO RELATED APPLICATION

The present application is based on and claims the benefit of U.S. provisional patent application Ser. No. 62/713,306, filed Aug. 1, 2018, the content of which is hereby incorporated by reference in its entirety.

### BACKGROUND

Eyewear, such as eye glasses, are not only a required eye sight correction devices for many people, but eye glasses have also become a fashion accessory worn with non-corrective lenses. Sunglasses have also become a popular accessory having a fashion and/or ornamental function as well as protecting the wearer's eyes from the sun's rays.

Various accessories have been combined with eyewear in the prior art, including headbands or visors in efforts to prevent a wearer from losing the eyewear when removed. The prior art integrates or combines the headgear accessories with the eyewear in a manner such that the headgear is not easily attachable or removable from the eyewear.

### SUMMARY

An aspect of the present disclosure relates to a method of securing a fashion and/or functional accessory to eyewear to allow a user to wear interchangeable accessories. The method comprises providing at least one sleeve comprising an attachment surface secured thereto and sliding the at least one sleeve onto an arm of the eyewear frame. One or more accessories, each having at least one secondary attachment surface thereon and also be provided and the accessories can be interchangeable secured to the eyewear by connecting at least one secondary attachment surface to the attachment surface of at least one sleeve for securing at least one of the one or more accessories to the eyewear frame.

The attachment surfaces may be complementary surfaces in a hook and loop fastener system.

The sleeve can be removably secured on to the arm of the eyewear frame by inserting a first end of the arm into first opening in the sleeve and sliding the arm there through and in one embodiment, a second opening in an opposing end of the sleeve allows for selectively adjusting the position of the sleeve along the length of the arm.

The sleeve may be a unitary construction and the attachment surface can be secured to an external surface of the sleeve along at least a portion of a length of the sleeve, which allows a wearer to selectively adjust a location of the connection between the attachment surface and the secondary attachment surface.

In one embodiment, the sleeve may have an attachment surface integrally formed therein such that the attachment surface is at least a portion of the sleeve length and a first side of the attachment surface is configured for connection with the at least one secondary attachment surface while a second opposing side of the attachment surface provides a sleeve wall for securing to the arm.

The accessories can be constructed from fabric, paper, plastic and other non-traditional materials, shapes and dimensions for securing to the eyewear frame. For example, the accessories may be one or more of a necklace, a dangling adornment, a fabric drape or a headband. The accessories are interchangeable and removably securable to the eyewear frame.

Another aspect of the present disclosure relates to a system for attaching one or more accessories to an eyewear frame for user wearing. The system comprises a first tubular sleeve comprising a first end, a second end, and a length extending there between wherein the first end comprises an opening configured to receive a portion of the eyewear frame there through such that the length is configured to cover a portion of the eyewear frame and wherein at least a portion of an external surface of the length comprises an attachment surface. One or more accessories comprising at least one secondary attachment surface are also provided and the secondary attachment surface is complementary to the attachment surface of the sleeve and configured for connection thereto. The system may further comprise a second tubular sleeve constructed in substantially the same manner and the first tubular sleeve.

The first tubular sleeve can be constructed from a flexible material and the attachment surface may be a first portion of a hook and loop fastener extending along a selected portion of the length of the sleeve.

The secondary attachment surface may be a second portion of a hook and loop fastener system for secure connection of the secondary attachment surface to the attachment surface of the tubular sleeve. The secondary attachment surface can be adhered to, sewn to, or otherwise secured to a surface of the accessory.

The sleeve can be removably securable to the eyewear frame and the accessory can be removably securable to the sleeve. Thus, accessories including but not limited to necklaces, dangling adornments, fabric drapes, headbands, hair coverings or combination thereof can be interchangeably secured to the eyewear frame and worn by a user.

### BRIEF DESCRIPTION OF THE DRAWINGS

FIG. 1 is a side view of an attachment mechanism configured to secure to an eyewear frame.

FIG. 2 is a perspective view of an accessory configured for attaching to the attachment mechanism of FIG. 1.

FIG. 3 is a front and back view of an embodiment of an attachment mechanism for connection with the mechanism of FIG. 1.

FIG. 4 is a perspective view an embodiment of an attachment mechanism for connection with the mechanism of FIG. 1.

### DETAILED DESCRIPTION

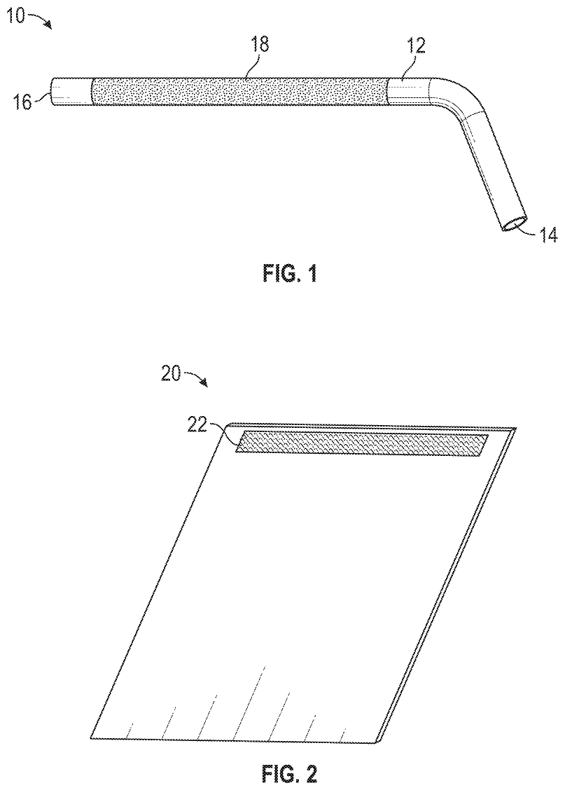

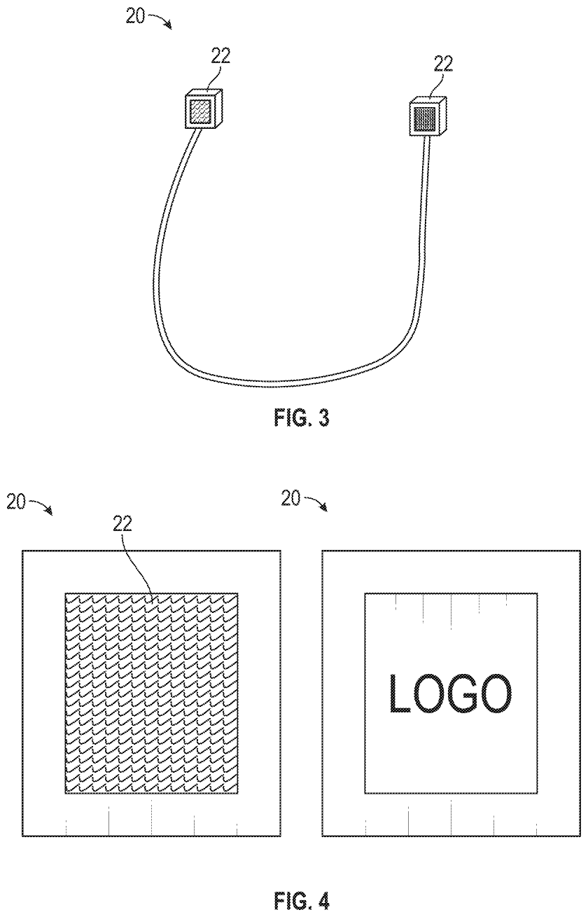

A removable attachment mechanism for various accessories wherein the attachment mechanism does not damage or permanently alter the eyewear device is described herein. The removable attachment mechanism is illustrated at 10 in FIG. 1. The eyewear device may be prescription glasses, reading glasses, fashion eyewear, sunglasses or other eyewear having a frame and generally worn by a user. The attachment mechanism 10 is configured for use on any frame configured to be supported on a user by the user's head and/or ears and wrap around a least a portion of the user's face or head. In one embodiment, the eyewear device comprises “temples,” otherwise known as arms or bows that are affixed to the frame front and extend around to behind the wearer's ears.

The removable attachment mechanism 10 described herein is used in connection with a fashionable and/or functional accessory 20. For example, a method of attaching fashionable and/or functional adornments 20 to eyewear temples is described herein. The adornments 20 can be accessories, including, but not limited to, patches and fabric pieces.

The adornments or accessories 20 are attached to the eyewear frame by sliding the attachment mechanism 10 over the eyewear temple. The attachment mechanism 10 may be a sleeve 12 configured to fit the temple portion of the eyewear frame and the sleeve is further adapted with one or more attachment surfaces 18. For example, the attachment surface 18 comprises a hook and loop fastener such as Velcro® for securing the accessories thereto.

The sleeve 12 may be comprised of a semi-stiff fabric base have a soft or smooth inner surface and the attachment surface comprising a flexible material. The sleeve 12 is configured to be removably secured to the eyewear and interchangeable accessories 20 removably secured to the eyewear. The sleeve 12 is also configured to be used on various eyewear frames and is removably securable thereto without damaging or leaving a residue, dent, scratch or other mark on the eyewear frame. Thus, various fashion and/or functional accessories 20 can be removably secured to eyewear and interchanged.

As described herein, the accessories 20 have an attachment surface 22 configured to mate with, or otherwise securely attach to, the attachment surface 18 of the attachment mechanism 10. For example, the accessories 20 are adapted with patches or other stripes of a hook and loop fastener for securing to the attachment mechanism 10. The accessory 20 is then configured to attach, drape or hang from the attachment mechanism 10.

A wearer can slide the sleeve 12 over the temple of selected eyewear (otherwise called an arm or bow). The attachment surface 18 is secured to the sleeve 12 by means including but not limited to sewing or an adhesive. In one embodiment, the sleeve 12 is a unitary tube wherein the hook and loop fastener is secured to one or more external surfaces of the sleeve. In another embodiment, the sleeve comprises one or more sections and a hook and loop fastener strip interconnecting the one or more sections to form a sleeve.

The sleeve 12 may be a tube having dimensions sufficient to fit over the temple of most eyewear with some limited stretching such that the sleeve fits securely and snugly over the temple for the eyewear. The sleeve may be provided in different sizes so as to accommodate the temple of various eyewear pieces, including larger or smaller temples without sliding off when in use. The sleeve 12 also has at least one open end 16 for insertion of the temple therein. Both ends of the sleeve 14, 16 may be open for positional adjustment along the length of the temple or one end may be closed. The length of the sleeve 12 may co-extend with the arm of the eyewear or substantially co-extend with the arm of the eyewear or may have a length less than the length of the arm of the eyewear.

In one embodiment the accessory 20 is any one of the accessories described herein including but not limited to a scarf, headband, neck wrap, hair wrap or similar accessory and said accessory is attached to eyewear via a pair of attachment mechanisms 10. A first attachment mechanism 10 is secured to a first end of the accessory 20 and a second attachment mechanism 10 is secured to an opposing end of the accessory 20. The attachment mechanisms 10 may then be coupled to the corresponding secondary surface on one or more locations on the accessory 20. The attachment mechanisms 10 may be secured to the accessory 20 via any one more embodiments described herein. Thus, the accessory 20 is secured around the wearer's head and/or neck and may drape from the wearer's ears (via connection to the eyewear) to cover the wearer's front, back, neck or otherwise serve as an article clothing or fashion accessory. The attachment mechanism 10 can be used in connection with additional attachment mechanisms 10 in order to secure various accessories to one or both arms or bows of the eyewear.

The accessories 20 described herein are connected to the eyewear by attaching or “sticking” the attachment mechanism of the accessory to the attachment mechanism secured to the eyewear. That is, the accessory is attached to the eyewear via mating or securing the attachment surfaces. This allows the accessory to hang from the temple.

The accessories described herein can be made of fabric, paper, plastic, or any blend of materials that can be affixed as described above. The measurements and dimensions vary depending on the selected accessory. These may represent, but are not limited to a necklace, dangling adornment, fabric drape or headband. These accessories may be modified using elastic, adorned with ornamentation and/or additional fabrics. The accessories may be fashion accessories and/or functional accessories.

The attachment mechanism may be sold as a kit comprising one or more attachment mechanisms and one or more accessories having the secondary attachment surface secured thereon.

The attachment mechanism may be sold as a kit comprising the primary attachment mechanism and the secondary attachment mechanism configured for attaching to a pre-existing accessory for securing the accessory to the eyewear. This kit may include a second primary attachment mechanism and secondary attachment mechanism configured for attaching to a pre-existing accessory for securing the accessory to the opposing bow or arm of eyewear.

Although the present disclosure has been described with reference to preferred embodiments, workers skilled in the art will recognize that changes may be made in form and detail without departing from the spirit and scope of the disclosure.

1. A method of securing an accessory to an eyewear frame comprising:
providing at least one sleeve comprising an attachment surface secured thereto;
sliding the at least one sleeve onto an arm of the eyewear frame;
providing one or more accessories each having at least one secondary attachment surface thereon; and
connecting at least one secondary attachment surface to the attachment surface of at least one sleeve for securing at least one of the one or more accessories to the eyewear frame.

2. The method of claim 1 wherein the attachment surface comprises a hook and loop fastener system and wherein the secondary attachment surface comprises a mating hook and loop fastener system.

3. The method of claim 2 and further comprising removably securing the at least one sleeve on to the arm of the eyewear frame by inserting a first end of the arm into first opening in the sleeve and sliding the arm therethrough and wherein a second opening in an opposing end of the sleeve allows for selectively adjusting the position of the sleeve on the arm.

4. The method of claim 1 wherein the sleeve is a unitary construction and the attachment surface is secured to an external surface of the sleeve along at least a portion of a length of the sleeve allowing for selectively adjusting a location of the connection between the attachment surface and the secondary attachment surface.

5. The method of claim 1 wherein the sleeve comprises an attachment surface integrally formed therein such that the attachment surface is at least a portion of the sleeve length and wherein a first side of the attachment surface is configured for connection with the at least one secondary attachment surface and a second opposing side of the attachment surface provides a sleeve wall for securing to the arm.

6. The method of claim 1 wherein the accessories are constructed from fabric.

7. The method of claim 1 wherein the accessories include one or more of a necklace, dangling adornment, fabric drape or headband.

8. A system for attaching one or more accessories to an eyewear frame for user wearing, the system comprising:
A first tubular sleeve comprising a first end, a second end, and a length extending there between;
wherein the first end comprises an opening configured to receive a portion of the eyewear frame there through such that the length is configured to cover a portion of the eyewear frame and wherein at least a portion of an external surface of the length comprises an attachment surface; and
at least one accessory, the accessory comprising at least one secondary attachment surface wherein the secondary attachment surface is complementary to the attachment surface of the sleeve and configured for connection thereto.

9. The system of claim 8 and further comprising a second tubular sleeve constructed in substantially the same manner and the first tubular sleeve.

10. The system of claim 8 wherein the first tubular sleeve is constructed from a flexible material and the attachment surface comprises a first portion of a hook and loop fastener extending along a selected portion of the length of the sleeve.

11. The system of claim 10 wherein the secondary attachment surface comprises a second portion of a hook and loop fastener system for secure connection of the secondary attachment surface to the attachment surface of the tubular sleeve.

12. The system of claim 8 wherein the secondary attachment surface is sewn to the accessory.

13. The system of claim 12 wherein the accessory is constructed from fabric.

14. The system of claim 8 wherein the attachment surface is secured to an external surface of the tubular sleeve.

15. The system of claim 8 wherein the attachment surface is integrally formed with the tubular sleeve.

16. The system of claim 8 wherein the accessory is one of a necklace, dangling adornment, fabric drape, headband or combination thereof.

17. The system of claim 8 wherein the sleeve is removably securable to the eyewear frame and wherein the accessory is removably securable to the sleeve.
